(19) United States
(12) Patent Application Publication
(10) Pub. No.: US 2008/0027694 A1
(43) Pub. Date: Jan. 31, 2008

(54) Heartbeat Simulation Method And Apparatus

(76) Inventor: Yury Michael Gitman, Atlanta, GA (US)

Correspondence Address: NEEDLE & ROSENBERG, P.C., SUITE 1000, 999 PEACHTREE STREET, ATLANTA, GA, 30309-3915, US

(21) Appl. No.: 11/457,082

(22) Filed: Jul. 12, 2006

(51) Int. Cl. G06G 7/48

(52) U.S. Cl. 703/11

(57) ABSTRACT

Provided are methods and apparatuses for dynamically generating a simulated tactile heartbeat sensation. The apparatus can comprise a vibrator, a processor, and a power source. The methods can comprise providing a digital pulse signal to a vibrator, the digital pulse signal being dynamically controlled by a processor.

### BACKGROUND OF THE INVENTION

The human heart produces two distinct sounds and vibrating waves in each cycle of the beat. The first having a rather dull sound and a larger vibrating amplitude caused by vibration of the auriculoventricular valves and by contraction of the ventricular muscle fibers; the second having a sharp sound and smaller vibration amplitude caused by the sudden closing of the aortic and pulmonary valves. Therefore, both vibrating waves are initiated in different moments of time and in separate locations inside of the human body. The hearts of other mammals work similarly.

Heartbeat simulators are intended to simulate a beating heart sensation to produce emotional responses of the human or instinctive responses of animals. Known heartbeat simulators utilize undulation of a single mass forced to pulsate by utilizing the inertia of mechanically or electrically loaded springs. These heartbeat simulators have limited ability to control a vibrating wave pattern or to allow a change of parameters in a vibration pattern. Known heartbeat simulators have an unrealistically unchanging heartbeat rhythm, and this limited vibration control results in low levels of realism of the simulated heartbeat sensation.

The heartbeat frequency of mammals is not constant. It is varied when a mammalian body reacts to a change in a physical condition of the body. The human heartbeat frequency is also affected by various emotional inputs. Such variations of real heartbeats are not simulated by known heartbeat simulators.

Other shortcomings of known heartbeat simulators include: limited electric power efficiency of tactile sensation generation, low longevity of mechanical vibrating components and low life of batteries due to high power consumption by mechanical vibrating components.

### SUMMARY OF THE INVENTION

Provided are methods and apparatuses for dynamically generating a simulated tactile heartbeat sensation. The apparatus can comprise a vibrator, a processor, and a power source. The methods can comprise providing a digital pulse signal to a vibrator, the digital pulse signal being dynamically controlled by a processor.

Additional advantages of the invention will be set forth in part in the description which follows or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 is an exemplary apparatus having one vibrator.

FIG. 2 is an exemplary apparatus having two vibrators.

FIG. 3 illustrates principles of Pulse Width Modulation.

FIG. 4 is a diagram illustrating an exemplary digital pulse signal output.

FIGS. 5A & B are diagrams illustrating exemplary digital pulse signal outputs.

FIG. 6 is a flow diagram illustrating an exemplary heartbeat simulation method.

FIG. 7 is a flow diagram illustrating an exemplary heartbeat simulation method.

FIG. 8 is a flow diagram illustrating an exemplary heartbeat simulation method.

FIG. 9 is a flow diagram illustrating an exemplary heartbeat simulation method.

### DETAILED DESCRIPTION OF THE INVENTION

Before the present methods and systems are disclosed and described, it is to be understood that this invention is not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data represents end points and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

“Optional” or “optionally” means that the subsequently described event or circumstance may or may not occur, and that the description includes instances where said event or circumstance occurs and instances where it does not.

The present methods and apparatuses may be understood more readily by reference to the following detailed description of preferred embodiments of the methods and apparatuses and the Examples included therein and to the Figures and their previous and following description.

I. Exemplary Apparatuses

In order to improve the realism of the tactile sensation, the present methods and apparatuses provide a heartbeat simulator having the ability to dynamically control a pattern of vibration pulses and to change a frequency of the heartbeat simulating pulses. Additionally, the mechanical pulse vibrating pattern and simulated heartbeat frequency may be changed in response to actions of a user (either local or remote) or a sensor. Sensors can include, but are not limited to, a pressure sensor, a movement sensor, a temperature sensor, a light sensor, a capacitance sensor, a heart rate sensor, a Galvanic sensor, a biofeedback electrode, a user switch, and the like.

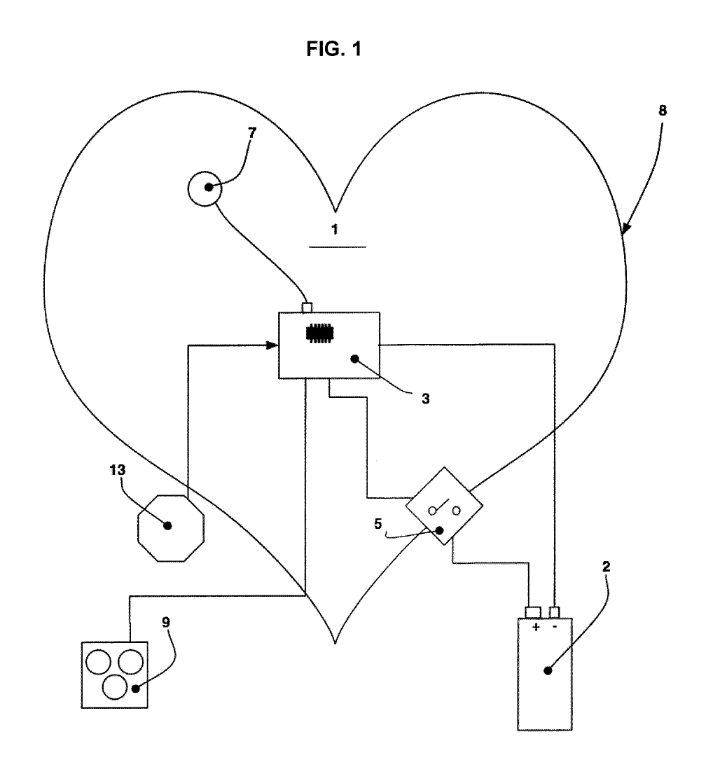

FIG. 1 illustrates an exemplary aspect of the apparatuses provided. A heartbeat simulator system 1 can comprise a power source 2. The power source 2 can generate an output voltage. The output voltage can be, for example, 3-9 volts. The power source 2 can be, for example, a battery. The power source 2 can be coupled to a microcontroller (or processor) 3. Any or a combination of suitable instruction execution systems, can be used as microcontroller 3, including discrete electronic components, a discrete logic circuit(s) having logic gates for implementing logic functions upon data signals, an application specific integrated circuit having appropriate logic gates, a programmable gate array(s) (PGA), a field programmable gate array (FPGA), and the like.

The microcontroller 3 can be programmed to generate one or more controllable digital pulse signal outputs. Each digital pulse signal output can have a voltage amplitude. The voltage amplitude can be, for example, in a range between 0.9v-4.0v. The heart beat simulator 1 can further comprise an on/off switch 5 coupled to the power source 2 and the microcontroller 3. The heart beat simulator 1 can further comprise a vibrator 7. The vibrator 7 can be, for example, a direct current vibrating (tactile) miniature motor.

The vibrator 7 can comprise an off-center (eccentric) mass attached to a shaft. When the eccentric mass rotates, a centrifugal force is transmitted through the entire motor as a vibration. The design of vibrator 7 can be similar to the design of tactile motors used as a high frequency vibrating source in cell phones and pagers, where these motors vibrate for a prolonged period of time (typically many seconds) to bring user attention to an incoming call. These vibrating motors are available in several design modifications having a rotating speed in the range of 5,000-15,000 rpm with direct current operating voltage specified for lowest voltage modifications in the range of 0.9-1.6 volts and for higher voltage modifications in the range of 2.5-4.0 volts. The vibrating frequency of these motors is many times higher than the pulsing frequency of human and animal hearts. The higher vibration of a tactile motor is perceived when higher direct current voltage (within operating range) is constantly applied to the motor. The tactile motor rotating mass can be enclosed in solid housing.

The vibrating frequency of the vibrator 7 (operating with supply voltages recommended by motor manufacturer) can be from 5 times to 100 times higher than the frequency of human and animal heartbeats that the heartbeat simulator system is applied to simulate.

In order to provide a user of the heartbeat simulator 1 with the ability to operate the heartbeat simulator system 1, either remotely or locally, the heartbeat simulator system 1 can comprise a remote console 9 coupled to the microcontroller 3. The remote console 9 can include one or more dials and/or switches that can be used to turn the simulator on and off, to vary the intensity of vibrations, to vary the speed of the heartbeat rhythm, and the like.

Where interaction between the heartbeat simulator system 1 and a user or the environment is desired to trigger a change in a simulated heartbeat one or more of sensor 13 can be coupled to the microcontroller 3. This coupling can modify a simulated heartbeat pulse amplitude, frequency or other heartbeat parameters in response to environmental changes and user actions. Sensor 13 can include, but is not limited to, a pressure sensor, a movement sensor, a temperature sensor, a light sensor, a capacitance sensor, a heart rate sensor, a Galvanic sensor, a biofeedback electrode, a user switch, and the like. The heartbeat simulator system 1 can comprise a variety of different sensors 13, for example, a pressure sensor and a temperature sensor. Sensor 13 can be employed to sense a defined user action (such as user movement, changes in the user's emotional state, user's body temperature, user's heartrate, and the like) and to transmit a signal representing such action to the microcontroller 3. Sensor 13 can be employed to sense an environmental change (such as a change in light, pressure, time, capacitance, temperature, and the like) and to transmit a signal representing such environmental change to the microcontroller 3.

The heartbeat simulator system 1 may further include an enclosure 8 to enclose several functional components of the system. The enclosure 8 can include, but is not limited to, a stuffed toy, a bed, a doll, a plastic enclosure, and the like.

When the heartbeat simulator system is used in an enclosure such as a doll or in a soft animal toy, the sensor 13 can be arranged as a pressure sensor or touch sensor, installed in the doll or in the soft animal toy to sense a hugging event and/or an intensity with which the user hugs the doll or the toy to generate and communicate a representative signal to the microcontroller 3. The signal communicated to the microcontroller 3 is recognized and used to exert dynamic programmable control of the vibrations of vibrator 7. This control modifies the tactile heartbeat sensation in response to the user event.

When the heartbeat simulator system 1 is used in an enclosure such as an infant baby bed to comfort and relax a baby by simulating the heartbeat of the mother's heart to which the baby has been accustomed during pregnancy of the mother, the sensor 13 can be placed under the top surface of the bed and can be arranged as a set of multiple pressure/touch switches. All switches in this set arrangement can be coupled to the microcontroller 3.

The switches can be used to recognize a baby positioning event on the bed. When a baby-positioning event is recognized by activation of at least one of said switches a related signal representing such switch activation is generated and communicated to the microcontroller 3 by the sensor 13. An example of a baby-positioning event includes placing the baby on the bed. When this event occurs, the sensor 13 can provide a signal to the microcontroller 3 to generate a heartbeat simulation pattern comprising a digital pulse signal having pulse signal outputs that gradually increase the vibration intensity so as not to disturb and scare the baby.

The multiple pressure and/or touch switches can be positioned under the top of the bed surface in such a manner that a defined change in the position of the baby laying on the top of the bed can cause an activation and/or a deactivation of at least one switch of the set. Such change in the switch status can be communicated to the microcontroller 3 as a related signal. The frequency with which such related signals are received by microcontroller 3 can be used by the microcontroller 3 as feedback indicating how much the baby has been disturbed or has been relaxed by the action of heartbeat simulator system 1. This allows the microcontroller 3 to dynamically modify the heartbeat simulation pattern parameters in response to the movements of the baby.

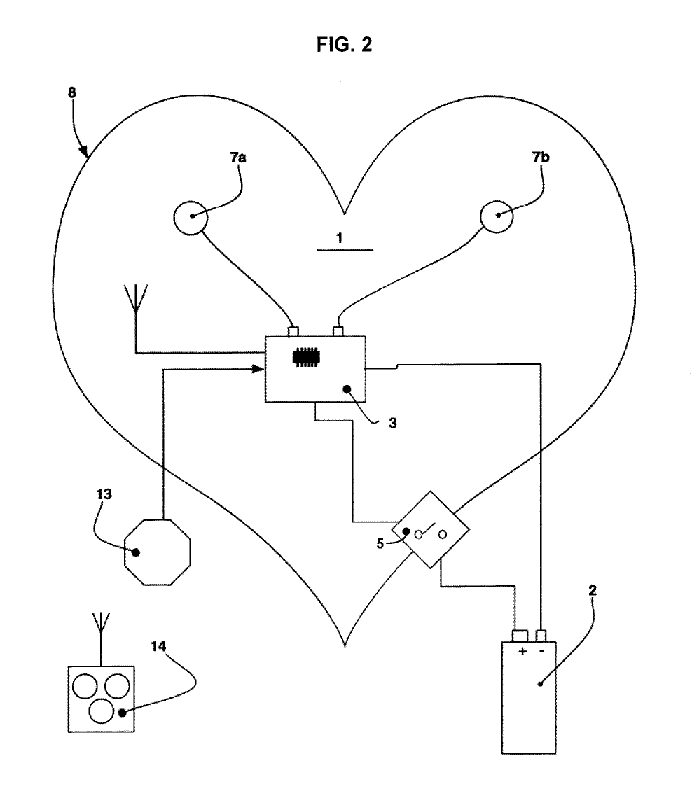

In another exemplary aspect, shown in FIG. 2, the heartbeat simulation system 1 can comprise components as described above. The heartbeat simulation system 1 can further comprise a vibrator 7a and a vibrator 7b. The location of the vibrators can be chosen taking into consideration the design and the use of the enclosure 8 in which heart simulator system 1 is installed. The vibrators can be positioned to provide for maximum tactile sensation on the apparatus surface, which is intended to be a prime contact surface communicating the heartbeat tactile sensation to the user of the apparatus. The vibrators can be distributed symmetrically on a primary contact surface, so that the distance between the two vibrators is equal to the distance of either vibrator to the primary contact surface edge.

The remote console 14 can be equipped with wireless connection capability to communicate with the microcontroller 3, which can be equipped with a wireless communication module and antenna.

The frequency and the amplitude of mechanical vibration of the vibrators 7, 7a, and 7b can not be well correlated with the value of electric power direct current voltage supplied to the motor because the mechanical vibration amplitude, frequency and waveform depend essentially on the parameters of an eccentric mass arrangement.

In order to control the vibration parameters of vibrators 7, 7a, and 7b, the microcontroller 3 provided can provide an output signal arranged as a digital pulse signal.

A dynamic change in a heartbeat pattern can be realized by the change of mechanical vibration mode of vibrators 7, 7a, and 7b (for example an increase in the frequency of reoccurrence of mechanical vibrating pulses generated by vibrators 7, 7a, and 7b), which is provided by varying the amplitude, cumulative power supplied, duty cycles, and the like, by dynamically controlled pulse signal outputs communicated by microcontroller 3 to vibrators 7, 7a, and 7b.

II. Exemplary Methods of Operation

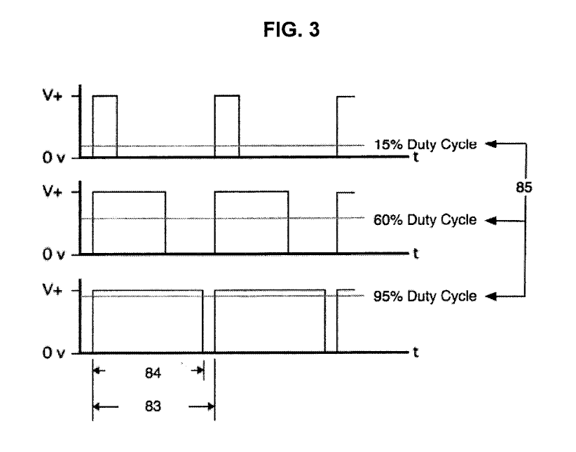

The aspects described herein can comprise dynamically controlling vibrator vibration through Pulse Width Modulation. FIG. 3 illustrates the basic principles of Pulse Width Modulation, or PWM. With PWM, a processor can send a series of pulse-on signals (also referred to as power-on signals) in a given period 83. The period can remain constant while the pulse-on width 84 can be varied by the processor. The pulse width 84 divided by the period 83 determines the duty cycle of the pulse signal. Duty cycle 85 can be expressed as a percentage of the full period. Using PWM, the processor can control a vibrator by turning it on and off very rapidly with a series of pulse-on signals and by allowing the inertia of the motor to average out the signal. By changing the duty cycle 85 the processor can effectively control the speed of the vibrator and the intensity of its vibration.

A. Operation with One Vibrator

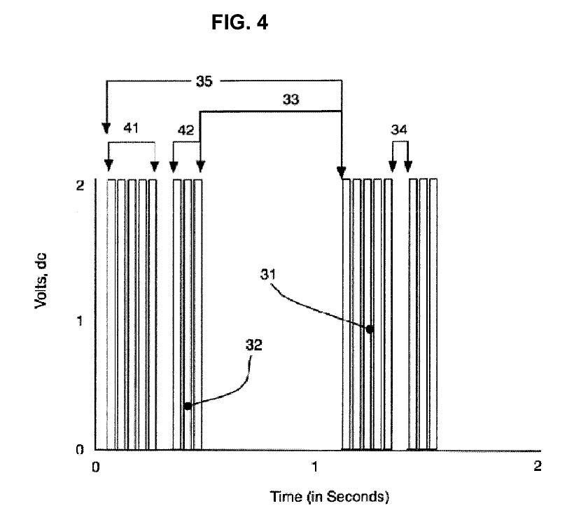

FIG. 4 illustrates an exemplary digital pulse signal comprising a plurality of pulse signal outputs (41 and 42), with each pulse signal output comprising one or more power-on signals (31 and 32). Each pulse signal output is separated from the following pulse signal output by a power-off pause (33 and 34), each power-off pause having a duration time. The duration time can be from 0.1 to 3.0 seconds. The microcontroller 3 can generate pulse signal outputs 41 and 42 with a recurring frequency, which correlates to a duration of time 35 elapsing between the two following reoccurrences of the pulse signal output 41 and the pulse signal output 42. The microcontroller 3 can maintain the recurring frequency of these pulse signal outputs equal to the frequency of a simulated heartbeat. For a human heartbeat, time 35 can be between 0.3 to 3.0 seconds.

The first pulse signal output 41 can be used to periodically energize and rotate vibrator 7 by directing one or more power-on signals to vibrator 7, to cause its vibrating pulsation to simulate the vibrating pulsation of the auriculoventricular valves of the heart. The second pulse signal output 42 can be used to periodically energize and rotate vibrator 7 by directing one or more power-on signals to vibrator 7, again to cause its vibration to simulate the vibrating pulsation caused by the sudden closing of the aortic and pulmonary valves of the heart. The power-on signals forming the first pulse signal output 41 provide vibrator 7 with a higher cumulative electric power input than the power-on signals forming the second pulse signal output 42. Each of the pulse signal outputs 41 and 42 can be arranged as a single power-on signal.

The first pulse signal output 41 can have a first time duration during which power-on signals having a longer combined period of time, and therefore higher cumulative electric power supply, can be generated. This first duration can be between 30 milliseconds and 300 milliseconds. The second pulse signal output 42 comprising power-on signals can have a second time duration, shorter than the first time duration, and lower cumulative electric power input. This second duration can be between 30 milliseconds and 300 milliseconds.

The sum of the first and the second time durations of pulse signals 41 and 42 can be at least 50% of time duration 35.

The simulated heartbeat pattern can be modified through controlling the pulse width of the pulse signal outputs 41 and 42. The power-on signals of both pulse signals outputs 41 and 42 can have the same pulse width, but it is also possible for one pulse signal output to have a shorter pulse width. The simulated heartbeat pattern can also be modified by altering a duty cycle of pulse signal outputs directed to the vibrator.

The simulated heartbeat pattern can also be modified through controlling the voltage amplitude of the pulse signal outputs 41 and 42. The power-on signal of both pulse signals outputs 41 and 42 can have the same voltage amplitude, but it is also possible for one pulse signal output to have a smaller voltage amplitude.

B. Operation with Two Vibrators

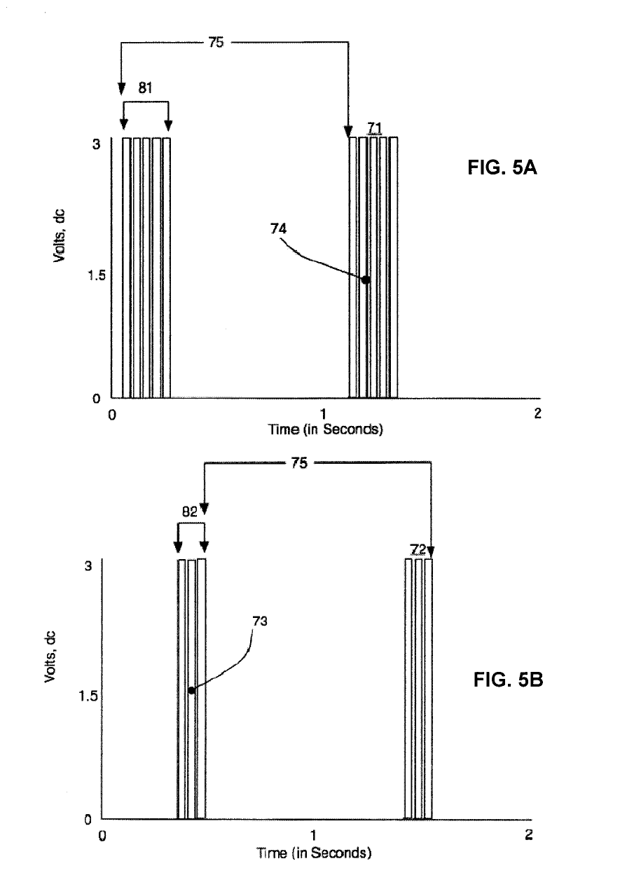

FIGS. 5A and 5B illustrate two exemplary digital pulse signals. FIG. 5A illustrates an exemplary digital pulse signal for controlling the vibration of a first vibrator 7a. FIG. 5B illustrates an exemplary digital pulse signal for controlling the vibration of a second vibrator 7b. Each of the pulse signal outputs 81, 71, 82, and 72 can be arranged as a single power-on signal.

FIG. 5A illustrates a digital pulse signal comprising a plurality of pulse signal outputs (81 and 71), with each pulse signal output comprising one or more power-on signals (74). The start of each pulse signal output (81 and 71) is separated from the following pulse signal output by a power-off pause (75), each power-off pause having a duration time. The duration time can be from 0.1 to 3.0 seconds. The microcontroller 3 can generate pulse signal outputs 81 and 71 with a recurring frequency, which correlates to a duration of time 75 elapsing between the start of two following reoccurrences of the pulse signal output 81 and the pulse signal output 71. The microcontroller 3 can maintain the recurring frequency of these pulse signal outputs equal to the frequency of a simulated heartbeat. For a human heartbeat, time 75 can be between 0.3 to 3.0 seconds. The pulse signal outputs 81 and 71 can be used to periodically energize and rotate vibrator 7a by directing one or more power-on signals to vibrator 7a, to cause its vibrating pulsation to simulate the vibrating pulsation of the auriculoventricular valves of the heart.

FIG. 5B illustrates a digital pulse signal comprising a plurality of pulse signal outputs (82 and 72), with each pulse signal output comprising one or more power-on signals (73). The start of each pulse signal output (82 and 72) is separated from the following pulse signal output by a power-off pause (75), each power-off pause having a duration time. The duration time can be from 0.1 to 3.0 seconds. The microcontroller 3 can generate pulse signal outputs 82 and 72 with a recurring frequency, which correlates to a duration of time 75 elapsing between the start of two following reoccurrences of the pulse signal output 82 and the pulse signal output 72. The microcontroller 3 can maintain the recurring frequency of these pulse signal outputs equal to the frequency of a simulated heartbeat. For a human heartbeat, time 75 can be between 0.3 to 3.0 seconds. The pulse signal outputs 82 and 72 can be used to periodically energize and rotate vibrator 7b by directing one or more power-on signals to vibrator 7b, to cause its vibrating pulsation to simulate the vibrating pulsation caused by the sudden closing of the aortic and pulmonary valves of the heart.

The pulse signal outputs 81 and 71 can have a first time duration during which power-on signals having a longer combined period of time, and therefore higher cumulative electric power supply, can be generated. This first duration can be between 30 milliseconds and 300 milliseconds. The pulse signal outputs 82 and 72 comprising power-on signals can have a second time duration, shorter than the first time duration, and lower cumulative electric power input. This second duration can be between 30 milliseconds and 300 milliseconds.

The sum of the first and the second time durations of pulse signals 81, 71, 82, and 72 can be at least 50% of time duration 35.

The simulated heartbeat pattern can be modified through controlling the pulse width of the pulse signal outputs 81, 71, 82, and 72. The power-on signals of pulse signals outputs 81, 71, 82, and 72 can have the same pulse width, but it is also possible for one or more pulse signal outputs to have a shorter pulse width. The simulated heartbeat pattern can also be modified by altering a duty cycle of pulse signal outputs directed to the vibrator.

The simulated heartbeat pattern can also be modified through controlling the voltage amplitude of the pulse signal outputs 81, 71, 82, and 72. The power-on signals of pulse signals outputs 81, 71, 82, and 72 can have the same voltage amplitude, but it is also possible for one or more pulse signal outputs to have a smaller voltage amplitude. The simulated heartbeat pattern can also be modified by altering a duty cycle of pulse signal outputs directed to the vibrator.

III. Exemplary Aspects

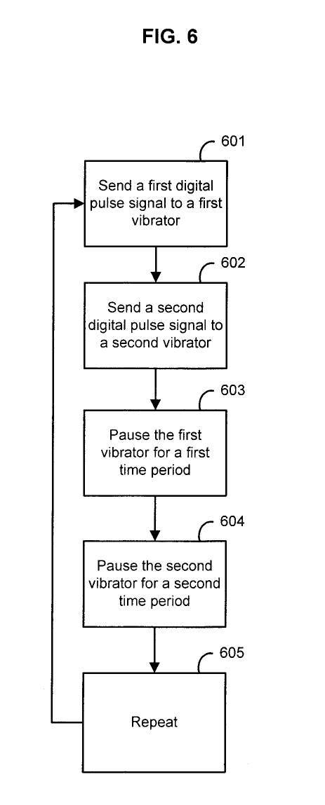

As shown in FIG. 6, provided are dynamic heartbeat simulation methods comprising: sending a first digital pulse signal to a first vibrator at step 601, sending a second digital pulse signal to a second vibrator at step 602, pausing the first vibrator for a first time period at step 603, pausing the second vibrator for a second time period at step 604, repeating steps 601, 602, 603, and 604 at step 605. The first time period can be from 0.1 to 3.0 seconds. The second time period can be from 0.1 to 3.0 seconds. The methods can further comprise altering the duty cycle of pulse signals directed to the vibrator. The methods can further comprise altering the pulse signals directed to the vibrator.

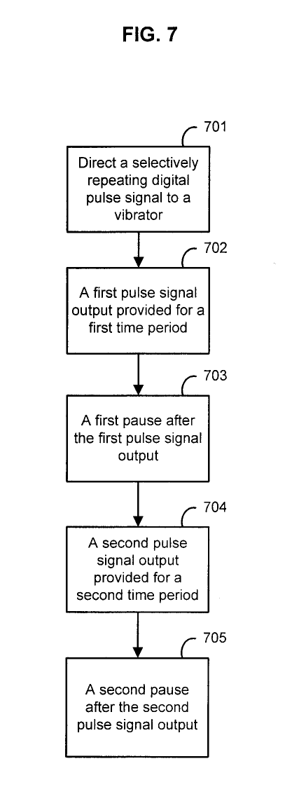

As shown in FIG. 7, also provided are dynamic heartbeat simulation methods comprising: directing a selectively repeating digital pulse signal to a vibrator at step 701, the digital pulse signal comprising a first pulse signal output provided for a first time period at step 702, a first pause after the first pulse signal output at step 703, a second pulse signal output provided for a second time period at step 704, and a second pause after the second pulse signal output at step 705. The length of the second pause duration can be altered within a defined minimum and maximum time period. Each pulse signal output can comprise a plurality of power-on signals, wherein the proportion of power-on signals over a predetermined period determines a pulse signal's duty cycle. The duration of the second pause can be greater than the sum of the first time period, the first pause duration, and the second time period. The sum of the first time period, the first pause duration, the second time period, and the second pause duration can be from 0.3 to 3.0 seconds.

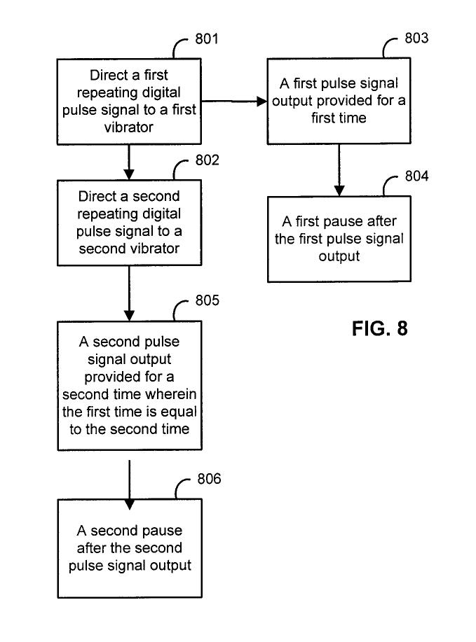

As shown in FIG. 8, also provided are dynamic heartbeat simulation methods comprising: directing a first repeating digital pulse signal to a first vibrator at step 801 and directing a second repeating digital pulse signal to a second vibrator at step 802. The first repeating digital pulse signal can comprise a first pulse signal output provided for a first time at step 803, and a first pause after the first pulse signal output at step 804. The second repeating digital pulse signal can comprise a second pulse signal output provided for a second time wherein the first time is equal to the second time at step 805, and a second pause after the second pulse signal output at step 806. Each pulse signal output can comprise a plurality of power-on signals, wherein the proportion of power-on signals over a predetermined period determines a pulse signal's duty cycle. The duration of the second pause is greater than the sum of the first time period, the first pause duration, and the second time period. The sum of the first time period, the first pause duration, the second time period, and the second pause duration can be from 0.3 to 3.0 seconds.

The pulse signal output can dynamically change in response to a sensor. The sensor can include, but is not limited to, a pressure sensor, a movement sensor, a temperature sensor, a light sensor, a capacitance sensor, a heart rate sensor, a Galvanic sensor, a biofeedback electrode, a user switch, and the like.

The pulse signal output can dynamically change in response to an input received through an input interface. The input interface can include a wired interface, a wireless interface, and the like.

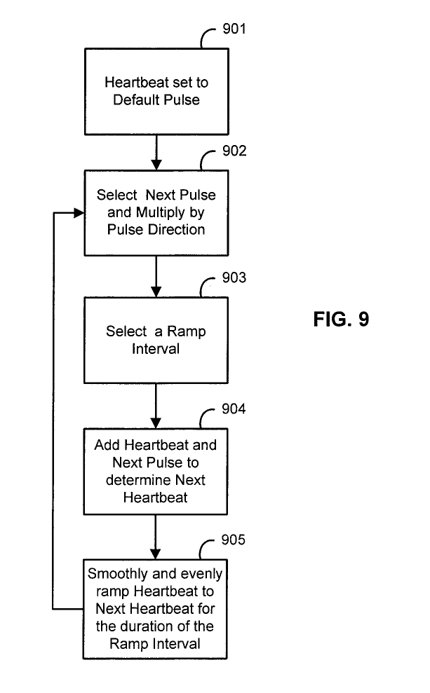

Also provided, and illustrated in FIG. 9, is a method for providing a unique simulated heartbeat, the method comprising setting a heartbeat to a default pulse at step 901, and randomly selecting a next pulse between a predetermined minimum and maximum pulse difference at step 902. The default pulse can be 72 beats/min. A pulse difference is the number of beats/min separating two pulses. The pulse difference can range from 5 to 15. The minimum pulse difference can be 5. The maximum pulse difference can be 15. The method can further comprise multiplying the next pulse by a pulse direction at step 902. Pulse direction is the random selection of the numeric value of either +1 or −1. Pulse direction determines if the next pulse will be faster or slower than the previous pulse. The method can further comprise selecting a ramp interval between a minimum ramp interval and a maximum ramp interval at step 903. Ramp interval is a numeric value determining the time in seconds in which the previous pulse transitions into the next pulse. The ramp interval can range from 5 to 15. The minimum ramp interval can be 5. The maximum ramp interval can be 15. The method can still further comprise adding the heartbeat and the next pulse to determine a next heartbeat at step 904. The method can comprise evenly and smoothly ramping the heartbeat to the next heartbeat for the duration of the ramp interval at step 905. The method can repeat when the heartbeat equals the next heartbeat. If the next heartbeat is set outside the boundaries of a minimum pulse or a maximum pulse, the next heartbeat can be set to the minimum pulse or a maximum pulse for the duration of the ramp interval. A minimum pulse can be 50 beats/min. A maximum pulse can be 140 beats/min.

The microcontroller 3 can dynamically implement changes in the simulated heartbeat by adjusting the values of the default pulse, the next heartbeat, the minimum pulse, the maximum pulse, the minimum difference, the maximum difference, the minimum ramp interval, the maximum ramp interval.

The methods for simulating a heartbeat described herein can be dynamically controlled. Alternatively, the methods for simulating a heartbeat described herein can be implemented in a static environment. For example, a heartbeat pattern can be generated using the methods provided, that pattern can subsequently be “hardeoded” into a heartbeat simulator apparatus.

While the methods ans apparatuses have been described in connection with preferred embodiments and specific examples, it is not intended that the scope of the invention be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A dynamic heartbeat simulation method comprising:
a. sending a first digital pulse signal to a first vibrator;
b. sending a second digital pulse signal to a second vibrator;
c. pausing the first vibrator for a first time period;
d. pausing the second vibrator for a second time period;
e. repeating steps a, b, c, and d.

2. The method of claim 1, further comprising altering the duty cycle of pulse signals directed to the vibrator.

3. The method of claim 1, further comprising altering the pulse signals directed to the vibrator.

4. A heartbeat simulating apparatus comprising:
at least one electrical vibrator;
a processor, electrically connected to the vibrator, wherein the processor dynamically controls vibration of the vibrator to simulate a heartbeat; and
a power source electrically connected to the processor.

5. The apparatus of claim 4, wherein dynamically controlling vibration of the vibrator comprises:
a. sending a first digital pulse signal to a first vibrator;
b. sending a second digital pulse signal to a second vibrator;
c. pausing the first vibrator for a first time period;
d. pausing the second vibrator for a second time period;
e. repeating steps a, b, c, and d.

6. The apparatus of claim 5, further comprising altering the duty cycle of pulse signals directed to the vibrators.

7. The apparatus of claim 5, further comprising altering the pulse signals directed to the vibrators.

8. The apparatus of claim 4, wherein the processor dynamically controls vibration of the vibrator to simulate a heartbeat by altering a duty cycle over intervals of time directed to the vibrator.

9. The apparatus of claim 4, wherein the processor controls the vibrator by directing a selectively repeating digital pulse signal to the vibrator, the digital pulse signal comprising:
a first pulse signal output provided for a first time period;
a first pause after the first pulse signal output;
a second pulse signal output provided for a second time period; and
a second pause after the second pulse signal output.

10. The apparatus of claim 9, wherein the processor dynamically controls vibration of the vibrator to simulate a heartbeat by altering the length of the second pause duration within a defined minimum and maximum time period.

11. The apparatus of claim 9, wherein each pulse signal output comprises a plurality of power-on signals, wherein the proportion of power-on signals over a predetermined period determines a pulse signal's duty cycle.

12. The apparatus of claim 9, wherein the duration of the second pause is greater than the sum of the first time period, the first pause duration, and the second time period.

13. The apparatus of claim 9, wherein the sum of the first time period, the first pause duration, the second time period, and the second pause duration is from 0.3 to 3.0 seconds.

14. The apparatus of claim 4, comprising a first vibrator and a second vibrator.

15. The apparatus of claim 14, wherein the processor controls the first vibrator through a first repeating digital pulse signal and the second vibrator through a second repeating digital pulse signal,
the first repeating digital pulse signal comprising:
a first pulse signal output provided for a first time;
a first pause after the first pulse signal output; and
the second repeating digital pulse signal comprising:
a second pulse signal output provided for a second time wherein the first time is equal to the second time; and
a second pause after the second pulse signal output.

16. The apparatus of claim 15, wherein each pulse signal output comprises a plurality of power-on signals, wherein the proportion of power-on signals over a predetermined period determines a pulse signal's duty cycle.

17. The apparatus of claim 15, wherein the duration of the second pause is greater than the sum of the first time period, the first pause duration, and the second time period.

18. The apparatus of claim 15, wherein the sum of the first time period, the first pause duration, the second time period, and the second pause duration is from 0.3 to 3.0 seconds.

19. The apparatus of claim 4, wherein the pulse signal output dynamically changes in response to a sensor.

20. The apparatus of claim 19, wherein the sensor is selected from the group consisting of:
a pressure sensor;
a movement sensor;
a temperature sensor;
a light sensor;
a capacitance sensor;
a Heart rate sensor;
a Galvanic sensor; and
a biofeedback electrode.

21. The apparatus of claim 4, further comprising an input interface wherein the pulse signal output dynamically changes in response to an input received through the input interface.

22. The apparatus of claim 21, wherein the input interface is selected from the group consisting of:
a wired interface; and
a wireless interface.

23. The apparatus of claim 9, wherein the pulse signal output dynamically changes in response to a user activated switch.

24. A dynamic heartbeat simulation method comprising:
a. sending a first digital pulse signal to a first vibrator;
b. pausing for a time period;
c. sending a second digital pulse signal to a second vibrator; and
d. repeating steps a, b, and c.

25. The method of claim 24, further comprising altering a duty cycle of the pulse signals directed to the vibrators.

26. The method of claim 24, further comprising altering the pulse signals directed to the vibrators.

27. A heartbeat simulating apparatus comprising:
at least one electrical vibrator;
a processor, electrically connected to the vibrator, wherein the processor controls vibration of the vibrator to simulate a heartbeat; and
a power source electrically connected to the processor.

28. The apparatus of claim 27, wherein controlling vibration of the vibrator comprises:
a. sending a first digital pulse signal to a first vibrator;
b. sending a second digital pulse signal to a second vibrator;
c. pausing the first vibrator for a first time period;
d. pausing the second vibrator for a second time period;
e. repeating steps a, b, c, and d.

29. The apparatus of claim 27, wherein the processor controls vibration of the vibrator to simulate a heartbeat by altering a duty cycle over intervals of time directed to the vibrator.

30. The apparatus of claim 27, wherein the processor controls the vibrator by directing a repeating digital pulse signal to the vibrator, the digital pulse signal comprising:
a first pulse signal output provided for a first time period;
a first pause after the first pulse signal output;
a second pulse signal output provided for a second time period; and
a second pause after the second pulse signal output.

31. The apparatus of claim 30, wherein each pulse signal output comprises a plurality of power-on signals, wherein the proportion of power-on signals over a predetermined period determines a pulse signal's duty cycle.

32. The apparatus of claim 30, wherein the duration of the second pause is greater than the sum of the first time period, the first pause duration, and the second time period.

33. The apparatus of claim 30, wherein the sum of the first time period, the first pause duration, the second time period, and the second pause duration is from 0.3 to 3.0 seconds.

34. The apparatus of claim 27, comprising a first vibrator and a second vibrator.

35. The apparatus of claim 34, wherein the processor controls the first vibrator through a first repeating digital pulse signal and the second vibrator through a second repeating digital pulse signal,
the first repeating digital pulse signal comprising:
a first pulse signal output provided for a first time;
a first pause after the first pulse signal output; and
the second repeating digital pulse signal comprising:
a second pulse signal output provided for a second time wherein the first time is equal to the second time; and
a second pause after the second pulse signal output.

36. The apparatus of claim 35, wherein each pulse signal output comprises a plurality of power-on signals, wherein the proportion of power-on signals over a predetermined period determines a pulse signal's duty cycle.

37. The apparatus of claim 35, wherein the duration of the second pause is greater than the sum of the first time period, the first pause duration, and the second time period.

38. The apparatus of claim 35, wherein the sum of the first time period, the first pause duration, the second time period, and the second pause duration is from 0.3 to 3.0 seconds.
